(19) United States
(12) Patent Application Publication
(10) Pub. No.: US 2026/0246073 A1
(43) Pub. Date: Aug. 20, 2026

(54) BATTERY SUBPACK WITH PASSIVE PROPAGATION RESISTANCE TO INTERCELL THERMAL RUNAWAY

(71) Applicant: BETA AIR LLC, South Burlington, VT (US)

(72) Inventors: Nathan Goldsberry, Winooski, VT (US); Yesaswi Chilamkurti, Williston, VT (US); Braedon Lohe, Essex Junction, VT (US); Tyler Collins, Frisco, TX (US)

(21) Appl. No.: 19/058,346

(22) Filed: Feb. 20, 2025

(51) Int. Cl. H01M 50/383; H01M 10/613; H01M 10/625; H01M 10/643; H01M 10/656; H01M 10/658; H01M 50/213; H01M 50/342; H01M 50/503; H01M 50/507; H01M 50/522; H01M 50/524; H01M 50/526

(52) U.S. Cl. CPC H01M 50/383; H01M 10/613; H01M 10/625; H01M 10/643; H01M 10/656; H01M 10/658; H01M 50/213; H01M 50/3425; H01M 50/503; H01M 50/507; H01M 50/522; H01M 50/524; H01M 50/526; H01M 2220/20

(57) ABSTRACT

Battery subpack components are arranged to deter thermal runaway propagation. A thermal gap between cell outer surfaces is selected to keep thermal load on neighbor cells below a threshold during cell thermal runaway. Current collector holes allow cell vent end ejecta to pass into a vent gap, along the subpack enclosure side wall, into a headspace, and to a burst plate. A repeating cell array has central axes of three neighbor cells around a first cell, yielding a right hexagonal prism shaped cell group such that prior art corner cells are eliminated for thermal and mechanical advantages.

### BACKGROUND

The disclosure relates generally to electric vehicle safety measures, and more particularly to battery cell thermal runaway safety measures.

In electric vehicle batteries, measures must be provided to handle the effects of thermal runaway of one or more cells of a battery of the electric vehicle. In ground-and water-based vehicles, thermal insulation of various types can be included with little consideration of the weight of such materials. However, weight is a high priority consideration for electric aircraft. Thus, thermal runaway measures for electric aircraft must use lighter materials and/or employ techniques to reduce weight more than ground- and water-based vehicles.

### BRIEF DESCRIPTION OF THE INVENTION

All aspects, examples and features mentioned below can be combined in any technically possible way.

An aspect of the disclosure provides a cell array comprising a first cell having a base, a vent end, a central axis, and an outer surface; a plurality of neighbor cells identical to the first cell and arranged with the respective central axes parallel to the central axis of the first cell and with the respective bases coplanar with the base of the first cell, wherein the plurality of neighbor cells includes at least three neighbor cells; and a respective thermal gap defined between the outer surface of the first cell and the respective outer surface of each neighbor cell, wherein the respective thermal gap is sized to maintain a thermal load on each neighbor cell below a predetermined threshold thermal load where the first cell enters a thermal runaway state.

Another aspect of the disclosure includes any of the preceding aspects, and wherein the plurality of neighbor cells is arranged with respective central axes thereof at points of a regular hexagon centered on the central axis of the first cell. wherein the plurality of neighbor cells includes at least six neighbor cells arranged with their respective central axes at points of a regular hexagon centered on the central axis of the first cell.

Another aspect of the disclosure includes any of the preceding aspects, and further comprising an outer layer of cells and a first internal layer of cells, wherein each cell of the outer layer of cells is a neighbor cell for at least one cell of the first internal layer of cells, and wherein each cell of the first internal layer of cells has at least two cells of the outer layer of cells as respective neighbor cells.

Another aspect of the disclosure includes any of the preceding aspects, and wherein the respective base of each cell engages a first surface of a heat exchange device.

Another aspect of the disclosure includes any of the preceding aspects, and wherein the cell array is a first cell array, and a second cell array identical to the first cell array is arranged such that the respective base of each cell of the second cell array engages a second surface of the heat exchange device, wherein the second surface of the heat exchange device is opposite the first surface of the heat exchange device.

Another aspect of the disclosure includes any of the preceding aspects, and wherein a thermally insulative material occupies each thermal gap.

An aspect of the disclosure provides a battery subpack comprising: a subpack enclosure; a heat exchange device in the subpack enclosure, wherein the heat exchange device has a first surface, a second surface opposite the first surface, a fluid passage between the first surface and the second surface, a fluid inlet, and a fluid outlet; and a first cell array including: a first cell having a base, a vent end, a central axis, and an outer surface; a plurality of neighbor cells identical to the first cell and arranged with respective central axis is parallel to the central axis of the first cell, wherein the plurality of neighbor cells includes at least three neighbor cells; and a respective thermal gap defined between the outer surface of the first cell and the respective outer surface of each neighbor cell, wherein the respective thermal gap is selected to maintain a thermal load on each neighbor cell below a predetermined threshold thermal load responsive to the first cell entering a thermal runaway state, wherein the first cell array is arranged with respective bases of the cells of the first cell array engaged with the first surface of the heat exchange device.

Another aspect of the disclosure includes any of the preceding aspects, and wherein a plurality of the first cell arrays is arranged to form a first outer layer of cells consisting of neighbor cells.

Another aspect of the disclosure includes any of the preceding aspects, and further comprising a second cell array identical to the first cell array, wherein the second cell array is arranged such that respective bases of the cells of the second cell array engage the second surface of the heat exchange device.

Another aspect of the disclosure includes any of the preceding aspects, and wherein a plurality of the first cell arrays is arranged to form a first outer layer of cells consisting of neighbor cells, and a plurality of the second cell arrays is arranged to form a second outer layer of cells consisting of neighbor cells.

Another aspect of the disclosure includes any of the preceding aspects, and wherein a thermally insulative material occupies each thermal gap.

Another aspect of the disclosure includes any of the preceding aspects, and further comprising a current collector disposed between the vent ends of the cell array and a corresponding wall of the subpack enclosure, wherein the current collector is in electrical communication with contacts of the cells of the first cell array and with a subpack electrical terminal formed in a back end of the subpack enclosure, and wherein the current collector is dimensioned and a material of the current collector is selected to enable ejecta from the vent ends of the cells of the first cell array to pass through the current collector during a thermal runaway event.

Another aspect of the disclosure includes any of the preceding aspects, and wherein the current collector includes holes aligned with the vent ends of the cell array.

Another aspect of the disclosure includes any of the preceding aspects, and wherein a thickness of the current collector is selected such that the ejecta from a thermal runaway event destroys material of the current collector in a path of the ejecta to pass through the current collector.

Another aspect of the disclosure includes any of the preceding aspects, and wherein a material of the current collector includes aluminum.

Another aspect of the disclosure includes any of the preceding aspects, and wherein the current collector comprises: a first electrically insulative layer made from a first polymer; a second electrically insulative layer made from a second polymer; and a first electrically conductive layer between the first electrically insulative layer and the second electrically insulative layer, wherein the electrically conductive layer is in electrical communication with respective first electrodes of the cells of the first cell array.

Another aspect of the disclosure includes any of the preceding aspects, and wherein at least one of the first polymer or the second polymer includes polyethylene terephthalate (PET).

Another aspect of the disclosure includes any of the preceding aspects, and wherein the first electrically conductive layer includes aluminum.

An aspect of the disclosure provides a battery subpack comprising: a subpack enclosure including a front end and a back end opposite the front end; a heat exchange device extending from the front end to the back end of the subpack enclosure, the heat exchange device including a first surface facing a first side wall of the subpack enclosure, a second surface facing a second side wall of the subpack enclosure, a fluid inlet, and a fluid outlet, wherein at least one of the fluid inlet or the fluid outlet is disposed at the front end of the subpack enclosure; and a first cell group on the first surface of the heat exchange device and a second cell group on the second surface of the heat exchange device, wherein each of the first cell group and the second cell group includes a plurality of cell arrays each including: a first cell having a base, a vent end, a central axis, and an outer surface; a plurality of neighbor cells identical to the first cell and arranged with respective central axis is parallel to the central axis of the first cell, wherein the plurality of neighbor cells includes at least three neighbor cells; and a respective thermal gap defined between the outer surface of the first cell and the respective outer surface of each neighbor cell, wherein the respective thermal gap is selected to maintain a thermal load on each neighbor cell below a predetermined threshold thermal load where the first cell enters a thermal runaway state; a current collector adjacent the vent ends of the cells and in electrical communication with electrodes thereof and with a terminal at the back end of the subpack enclosure; wherein the respective bases of the cells of the first cell group and the second cell group have a direct thermal connection with the first surface of the heat exchange device and the second surface of the heat exchange device, respectively, and wherein the respective vent ends of the cells of the first cell group and the second cell group are proximate and spaced apart from the first side wall of the subpack enclosure and the second side wall of the subpack enclosure, respectively, such that respective vent gaps are defined between the respective side walls of the subpack enclosure and the respective collectors of the first cell group and the second cell group.

Another aspect of the disclosure includes any of the preceding aspects, and wherein each current collector includes a pair of terminals in electrical communication with respective connectors extending through a back end wall of the subpack enclosure.

Two or more aspects described in this disclosure, including those described in this summary section, may be combined to form implementations not specifically described herein.

The details of one or more implementations are set forth in the accompanying drawings and the description below. Other features, objects and advantages will be apparent from the description and drawings, and from the claims.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a schematic isometric elevation of a battery cell according to aspects of the disclosure;

FIG. 2 shows an isometric elevation of a battery subpack according to aspects of the disclosure focusing on a front end thereof;

FIG. 3 shows an isometric elevation of a battery subpack according to aspects of the disclosure focusing on a back end thereof;

FIG. 4 shows an isometric elevation of groups of cells in a battery subpack according to aspects of the disclosure as seen in FIG. 1 with the subpack enclosure and other components removed;

FIG. 5 shows a cross section view of a battery subpack according to aspects of the disclosure;

FIG. 6 shows an elevation view of a heat exchange device according to aspects of the disclosure;

FIG. 7 shows a schematic view of a cell array according to aspects of the disclosure;

FIG. 8 shows a group of cells employing the cell array according to aspects of the disclosure;

FIG. 9 shows an elevation view of a battery subpack according to aspects of the disclosure as seen in FIG. 3 with the subpack enclosure removed to show a current collector and other components of the battery subpack;

FIG. 9 shows an elevation view of a portion of the current collector seen in FIG. 5 according to aspects of the disclosure;

FIG. 10 shows a schematic top projection view of a current collector according to aspects of the disclosure;

FIG. 11 shows a schematic top projection view of a portion of a current collector according to aspects of the disclosure; and

FIG. 12 is a partial cross-sectional view of battery subpacks according to aspects of the disclosure.

It is noted that the drawings of the disclosure are not necessarily to scale. The drawings are intended to depict only typical aspects of the disclosure and therefore should not be considered as limiting the scope of the disclosure. In the drawings, like numbering represents like elements between the drawings.

### DETAILED DESCRIPTION

As an initial matter, in order to clearly describe the current disclosure, it will become necessary to select certain terminology when referring to and describing relevant machine components within the illustrative application of a battery subpack and cell array therefor. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part. It should be understood that embodiments disclosed herein may be described in the context of and or implementation in electric aircraft, but could also be implemented in other electric vehicles as suitable and/or desired. That said, embodiments as disclosed herein include features that can particularly enhance desirability for use in aircraft, such as the use of alternative materials, structures, and/or methods resulting in reduced vehicle weight and/or enhanced aircraft safety.

In addition, several descriptive terms may be used regularly herein, and it should prove helpful to define these terms at the onset of this section. These terms and their definitions, unless stated otherwise, are as follows. As used herein, “downstream” and “upstream” are terms that indicate a direction relative to the flow of a fluid, such as a coolant employed during operation of an electric vehicle using embodiments of the disclosure or, for example, the flow of air through and/or around an electric vehicle, such as an electric aircraft, in which embodiments of the disclosure are deployed. The term “downstream” corresponds to the direction of flow of the fluid, and the term “upstream” refers to the direction opposite to the flow. The terms “forward” and “aft,” without any further specificity, refer to directions, with “forward” or “fore” referring to the front or nose of an electric aircraft, and “aftward” or “aft” referring to the rearward or tail end of the aircraft.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. In addition, several descriptive terms may be used regularly herein, as described below. The terms “first,” “second,” and “third,” may be used interchangeably to distinguish one component from another and are not intended to signify location or importance of the individual components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur or that the subsequently described component or element may or may not be present and that the description includes instances where the event occurs or the component is present and instances where the event does not occur or the component is not present.

Where an element or layer is referred to as being “on,” “engaged to,” “engaging,” “connected to,” “coupled to,” or “mounted to” another element or layer, it may be directly on, engaged, connected, coupled, or mounted to the other element or layer, or intervening elements or layers may be present. In contrast, when an element is referred to as being “directly on,” “directly engaged to,” “directly engaging,” “directly connected to,” or “directly coupled to” another element or layer, no intervening elements or layers are present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. The verb forms of “couple,” “connect,” “attach,” and “mount” may be used interchangeably herein.

Aspects of the disclosure provide a battery subpack with a cell array therefor including features providing passive thermal runaway propagation prevention. In the event that a first cell of the battery subpack enters a thermal runaway state, neighbor cells of the first cell will experience thermal load below a threshold amount representing a thermal load that would send one or more of the neighbor cells into the thermal runaway state. By studying thermal gradients experienced by battery cells in battery packs, battery subpacks, and smaller groupings therein, it has been determined that thermal runaway propagation can be avoided by ensuring that there is a minimum thermal gap between outer surfaces of the first cell and the neighbor cells around the first cell. Thermal gradient study also revealed that a hexagonal arrangement of the cells of the battery subpack can eliminate prior art corner cells that could produce hot spots in a prior art battery subpack. Such a hexagonal arrangement of the cells can be achieved by using an arrangement of the cells, referred to herein as a cell array, that can be repeated as needed until a desired number of cells has been reached in a battery subpack.

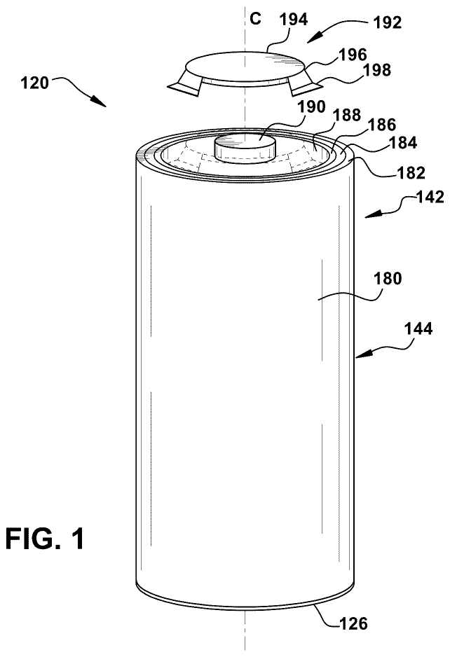

FIG. 1 shows an example of a cell 120 that can be used in embodiments of the disclosure. Cell 120 includes a base 126 and a vent end 142 opposite base 126 with a body 180 extending therebetween. Body 180 has an outer surface 144, and vent end 142 includes an insulative jacket 182, an anode 184, an insulative layer 186, a vent 188, and a cathode 190. As seen in FIG. 1, cell 120 has a central axis C extending longitudinally and with which all components of cell 120 are aligned. As is known in the art, an electrolyte is disposed within body 180 of cell 120 such that ions are exchanged between anode 184 and cathode 190 to produce electric potential and/or current therebetween. A cap 192 covers cathode 190 and includes a contact 194 made from a conductive material and which can be a disc. Contact 194 is supported by legs 196 that include feet 198. Cap 192 is shown above its operative position, which is shown in dashed lines where feet 198 rest on vent 188 and engage insulative layer 186. It should be noted that while cell 120 is illustrated as cylindrical, which is preferred, cells of other shapes could be employed within the scope of embodiments. Cell 120 can advantageously be rechargeable, particularly of the lithium ion type or the lithium metal type of rechargeable cell, as non-limiting examples. During operation, vent 188 can allow gas to escape cell 120, and during a thermal runaway event, vent 188 can allow ejecta, such as hot gas, liquid, particles, and other material, to escape cell 120. Cap 192 can be forced off vent end 142 during such a thermal runaway event by escaping ejecta, or ejecta can escape around cap 192, depending on the particular manner in which feet 198 are connected to vent end 142.

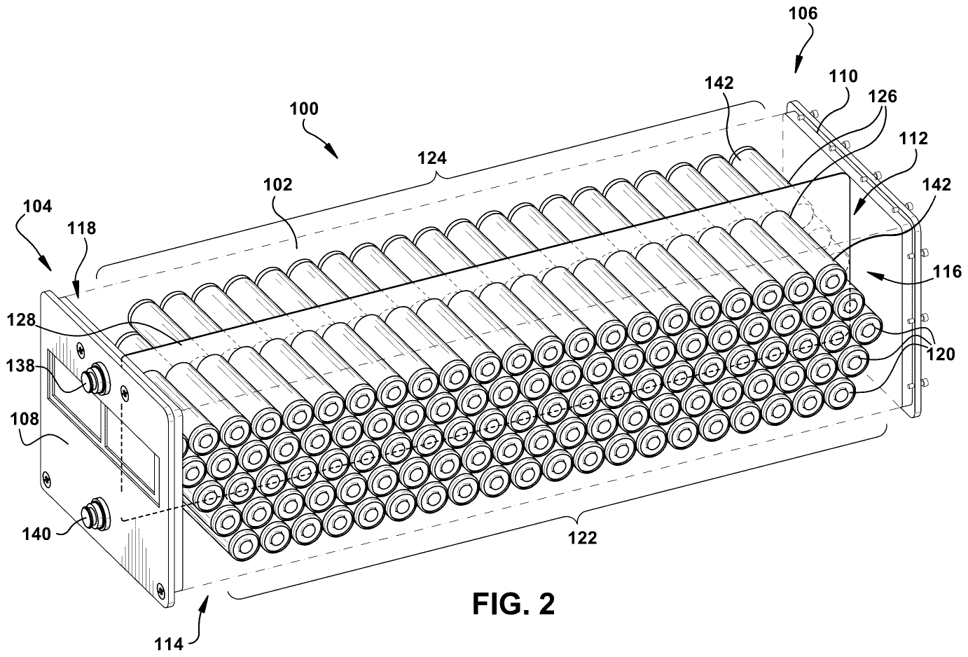

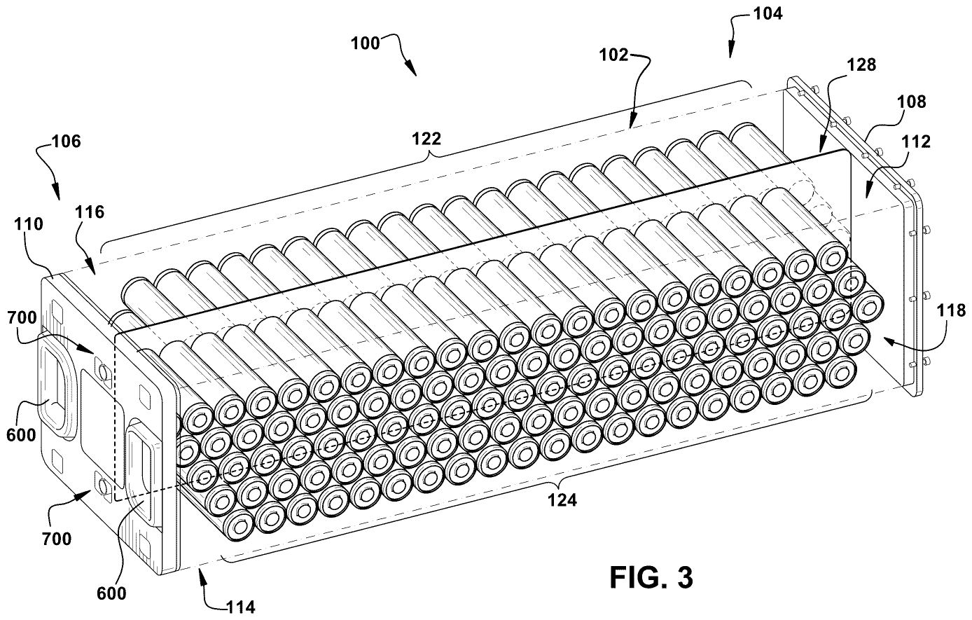

Turning now to FIGS. 2 and 3, a battery subpack 100 according to aspects of the disclosure is shown. Battery subpack 100 can include a subpack enclosure 102 having a front end 104 and a back end 106. Subpack enclosure 102 can include a front end wall 108, an back end wall 110, a top wall 112, a bottom wall 114, a first side wall 116, and a second side wall 118 opposite first side wall 116. Battery cells 120 are disposed within subpack enclosure 102, such as in a first cell group 122 and a second cell group 124. As seen in FIG. 2, bases 126 of cells 120 in first cell group 122 face bases 126 of cells 120 in second cell group 124. As a result of close packing, cells 120 appear in a hexagonal arrangement of cells 120 according to embodiments of the disclosure can be seen in both cell groups 122, 124 in FIGS. 2 and 3. In other embodiments, such packing and such a pattern need not be employed. As particularly seen in FIG. 2, back wall 110 can include electrical connector assemblies 600 and data connector assemblies 700, as will be described hereinafter.

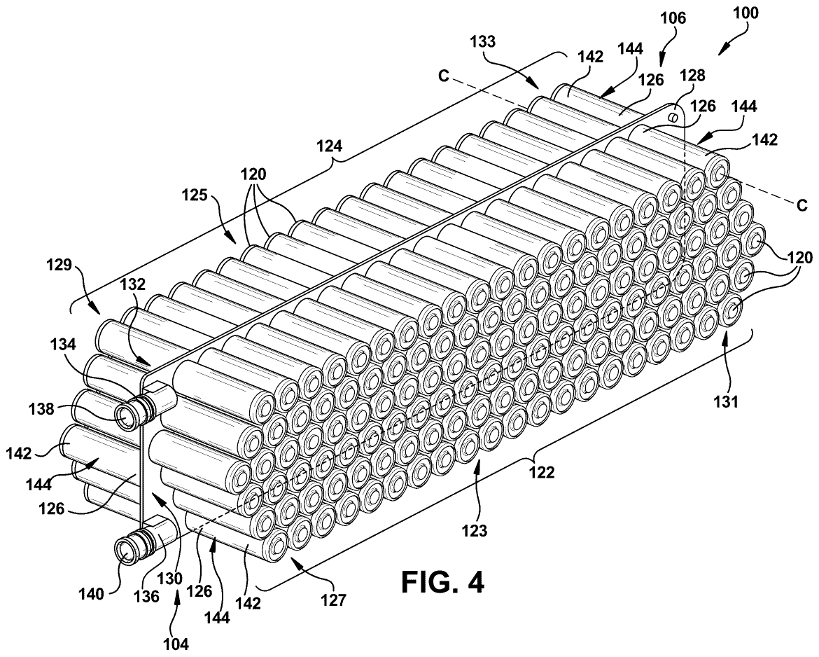

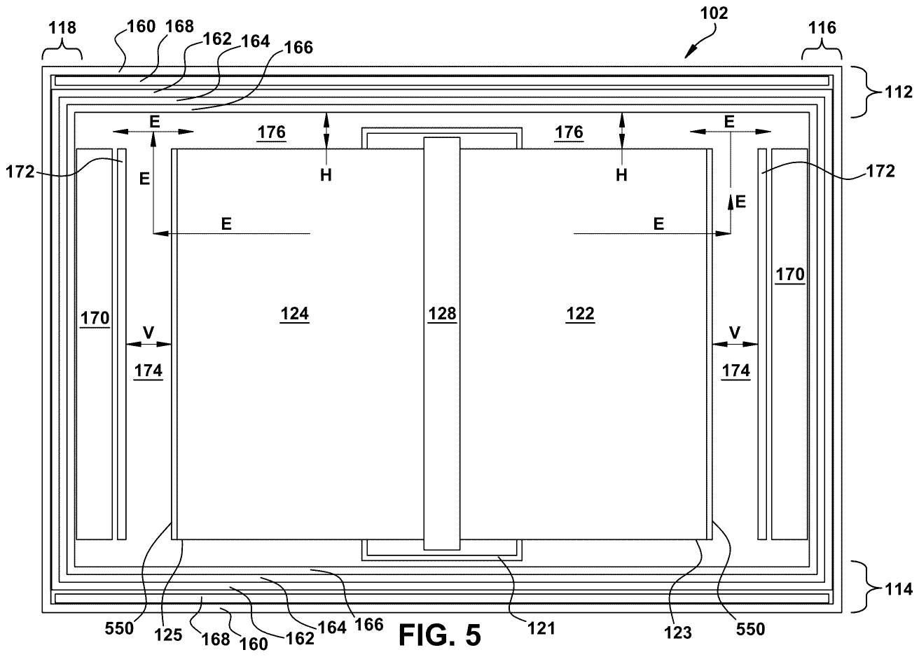

Turning now to FIG. 4, where subpack enclosure 102 is removed from battery subpack 100, bases 126 of cells 120 of each cell group 122, 124 can engage a respective opposed surface of a heat exchange device 128. In embodiments, a cell retainer 121 seen in cross section in FIG. 5 can surround at least a portion of cell groups 122, 124 to hold cells 120 in place against heat exchange device 128. Cell retainer 121 (FIG. 5) can surround at least a portion of both cell groups 122, 124, or each cell group 122, 124 can have a respective cell retainer 121 (FIG. 5), and in either case, cell retainer(s) 121 (FIG. 5) can also engage heat exchange device 128 if suitable and/or desired. Thus, in the example shown in FIG. 4, bases 126 of cells 120 in first cell group 122 can engage a first surface 130 of heat exchange device 128, and bases 126 of cells 120 in second cell group 124 can engage a second surface 132 of heat exchange device 128 that is opposite first surface 130 of heat exchange device 128. As a result, vent ends 142 of cells 120 in both cell groups 122, 124 are directed away from heat exchange device 128, forming respective vent sides 123, 125 of cell groups 122, 124. Cell groups 122, 124 also have respective front ends 127, 129 to which thermal runaway ejecta is directed, and back ends 131, 133 opposite the front ends 127, 129 that include electrical and data passthroughs that might be susceptible to damage from the temperatures exhibited by thermal runaway ejecta.

As seen in the cross-sectional view of subpack enclosure 102 in FIG. 5, a vent gap 174 of size V is defined between vent sides 123, 125 of cell groups 122, 124 and a respective innermost layer of respective side walls 116, 118. During a thermal runaway event, ejecta E is directed away from heat exchange device 128, out vent sides 123, 125 of cell groups 122, 124, and into vent gap 174. In vent gap 174, an innermost layer of side wall 116, 118 is positioned to direct ejecta E along side wall 116, 118 to a headspace 176 defined between cell croup 122, 124 and top wall 112 of subpack enclosure 102. In headspace 176, ejecta E moves toward front end 106 (FIG. 2) of subpack enclosure 102.

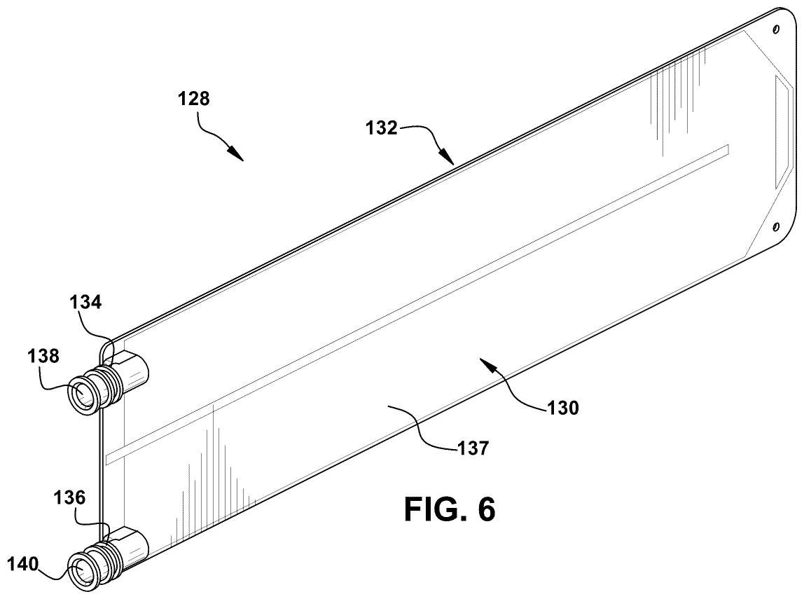

In certain embodiments, as particularly seen in FIG. 6, heat exchange device 128 can include a fluid inlet 134 and a fluid outlet 136 to provide flow of a fluid through a fluid passage 137 between first surface 130 and second surface 132. Preferably, as shown in FIG. 3, at least one of fluid inlet 134 and fluid outlet 136 is disposed at front end 104 of subpack enclosure 102. It can be advantageous in embodiments for both of fluid inlet 134 and fluid outlet 136 to be formed or positioned at front end 104 of subpack enclosure 102, in which case fluid inlet 134 and/or fluid outlet 136, and/or respective connectors 138, 140 therefor, can extend through front end wall 108 of subpack enclosure 102 (FIG. 2). In certain embodiments, heat exchange device 128 can be a cold plate through which a liquid coolant and/or air can circulate to exchange heat between cells 120 and a heat source and/or sink outside of battery subpack 100.

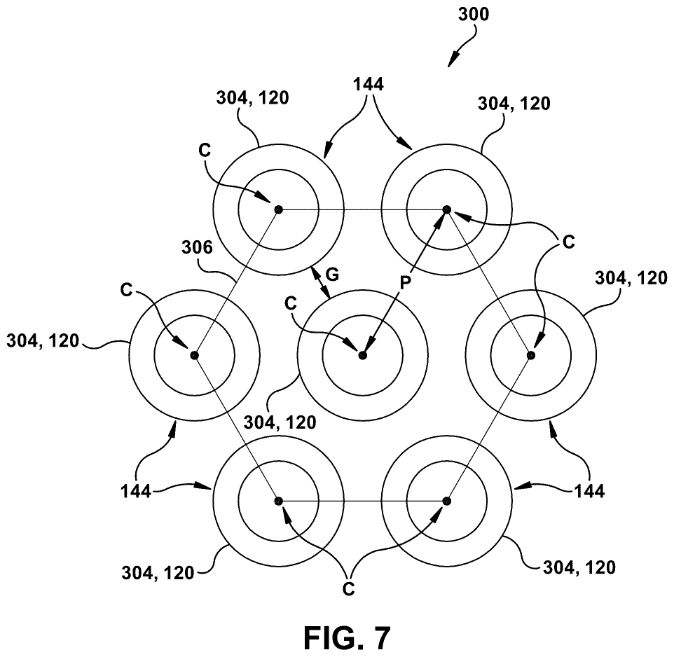

Reference is now made to FIG. 7, which shows a cell array 300 according to embodiments, which can be used to organize cells in a battery subpack. Cell array 300 includes a plurality of cells 120, which can include a first cell 302 and a plurality of neighbor cells 304 identical to first cell 302, which, referring back to FIG. 1, all have a respective base 126, vent end 142, central axis C, and outer surface 144. Returning to FIG. 7, the plurality of neighbor cells 304 is arranged such that respective central axes C of neighbor cells 304 are parallel to the central axis C of first cell 302. Preferably, as shown in FIG. 4, neighbor cells 304 are also arranged such that the respective bases 126 (FIG. 4) thereof are coplanar with base 126 (FIG. 4) of first cell 302.

As seen in FIG. 7, a respective thermal gap G is defined between outer surface 144 of first cell 302 and the respective outer surface 144 of each neighbor cell 304. Each respective thermal gap G is selected, i.e., sized, to maintain a thermal load on each neighbor cell 304 below a predetermined threshold thermal load should first cell 302 enter a thermal runaway state. In addition, as illustrated between first cell 302 and top left neighbor cell 304 in FIG. 7, cell array 300 can include a cell center distance P between the respective central axes C of the first cell 302 and each of the plurality of neighbor cells 304, where the cell center distance P is selected, i.e., sized, to ensure the thermal gap G is present, e.g., between outer surfaces 144 of first cell 302 and neighbor cells 304 in cell array 300. As also seen in FIG. 7, it is advantageous in embodiments that the plurality of neighbor cells 304 include at least three neighbor cells 304 arranged with their respective central axes C at points of a regular hexagon 306 centered on the central axis C of first cell 302. Preferably, thermal gap G is occupied by air, or a partial or total vacuum, to provide thermal insulation without adding weight to battery subpack 100.

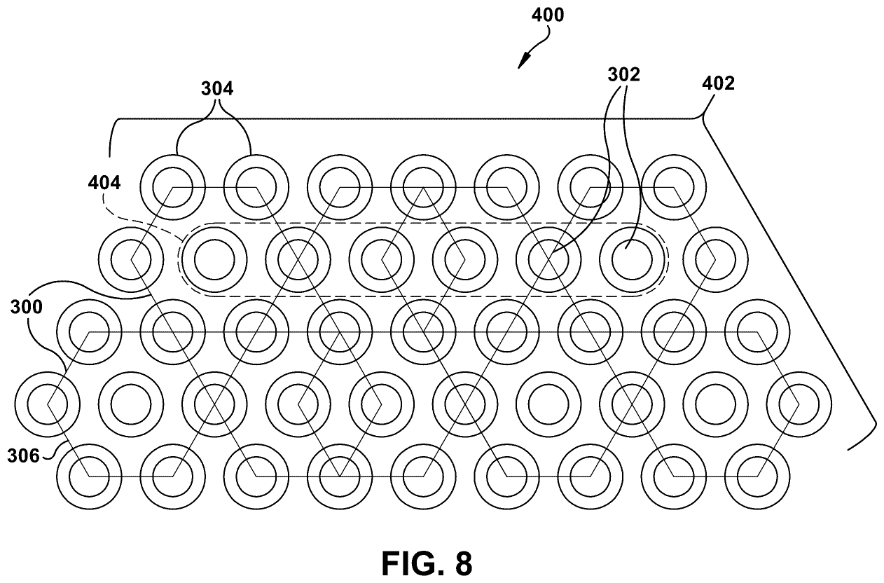

Using cell array 300, one can group cells 120 to avoid prior art square corner cells that can lead to hot spot formation. For example, as seen in FIG. 8, an arrangement 400 of cells 120 can include an outer layer 402 of cells 120 and a first internal layer 404 of cells 120. In the example shown in FIG. 7, referring to cell array 300 of FIG. 7, each cell 120 of outer layer 402 of cells 120 is a neighbor cell 304 (FIG. 7) for at least one cell 120 of first internal layer 404 of cells 120. In addition, each cell 120 of first internal layer 404 of cells 120 has at least two cells 120 of outer layer 402 as respective neighbor cells 304 (FIG. 7). By repeatedly applying cell array 300 (FIG. 7) to arrangement 400, a desired number of cells 120 can be placed into a close packed formation as illustrated in FIG. 8 with suitable thermal gaps G therebetween. It should be understood that the particular number and dimensions of arrangement 400 are illustrative only and not limiting.

As an additional example, cell array 300 (FIG. 7) can be used in one or both of first and second cell groups 122, 124 as seen in FIGS. 2-4. For example, in first cell group 122, a first cell array 300 (FIG. 7) can have the respective base 126 of each cell 120 engage first surface 130 of heat exchange device 128, and in second cell group 124 a second cell array 300 (FIG. 7) identical to the first cell array can be arranged such that the respective base 126 of each cell 120 of the second cell array 300 engages second surface 132 of heat exchange device 128. Second surface 132 of heat exchange device 128 is opposite first surface 130 of heat exchange device 128. Each of first and second cell groups 122, 124 represent a plurality of cell arrays 300 (FIG. 7) applied to produce the hexagonal arrangement observed in FIGS. 2-4. First and second cell groups 122, 124 will have respective outer layers (see outer layer 402 in FIG. 8) of cells 120 and one or more inner or internal layers (see internal layer 404 in FIG. 8) of cells 120. As a result of using cell array 300 (FIG. 7) in arrangement 400 (FIG. 8) and/or one or both of first and second cell groups 122, 124 (FIGS. 2-4), an appropriate thermal gap G will be present between all cells 120, thus passively resisting propagation of thermal runaway should one cell enter a thermal runaway state.

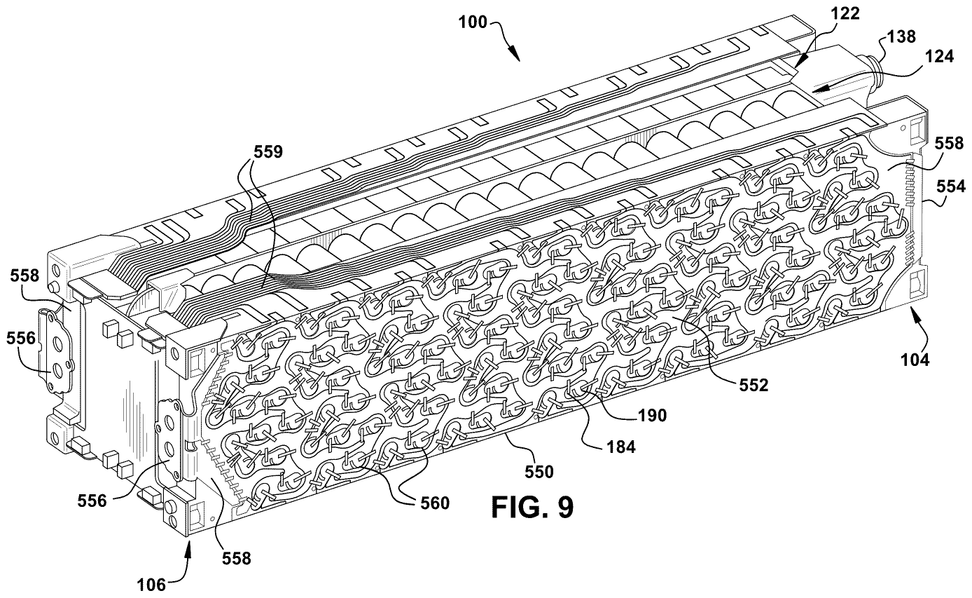

Turning now to FIG. 9, battery subpack 100 is shown in an elevation with subpack enclosure 102 (FIGS. 2 and 3) removed and in which back end 106 is foremost. Each side of battery subpack 100 includes a current collector 550. With additional reference to FIGS. 1-4, current collector 550 along respective cell group 122, 124 and is connected thereto so as to achieve a desired voltage and/or current. A conductive layer 552 of each current collector 550 is connected to a respective electrical terminal 556 at back end 106 of battery subpack 100 and to the other current collector 550 via a busbar 554 at front end 104 of battery subpack 100 in series. So connected, with a suitable connection pattern between cell groups 122, 124 and current collectors 550, one electrical terminal 556 is an anode of battery subpack 100 and the other electrical terminal 556 is a cathode of battery subpack 100. Conductive layer 552 of current collector 550 can also include measurement leads 559 connected to data terminals of data passthrough assemblies 700 (FIG. 3). In embodiments, conductive layer 552 can include a metal, such as aluminum and/or copper.

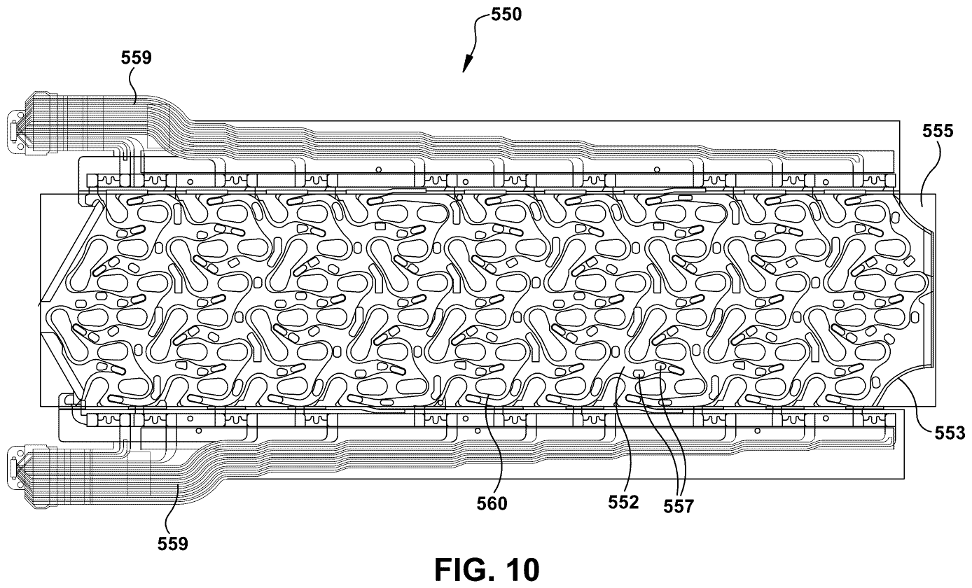

As seen in FIG. 9 and with additional reference to FIG. 10, current collector 550 includes holes 560 aligned and sized to allow ejecta to pass from vents 188 (FIG. 1) through current collector 550. As particularly seen in FIG. 10, conductive layer 552 can be between a first electrically insulative layer 553 and a second electrically insulative layer 555 through which holes 560 extend. First electrically insulative layer 553 can also include openings 557 to conductive layer 552 to allow connection of cell electrodes to conductive layer 552. One or both of first and second electrically insulative layers 553, 555 can include a suitable material, such as a dielectric material or a polymer, which can include materials such as polyethylene terephthalate (PET). In some embodiments, current collector 550 can be formed without holes 560 or with holes in only some layers. In such embodiments, current collector 550 is sized and materials therefore are selected to allow cell ejecta E to destroy material of current collector 550 to pass therethrough.

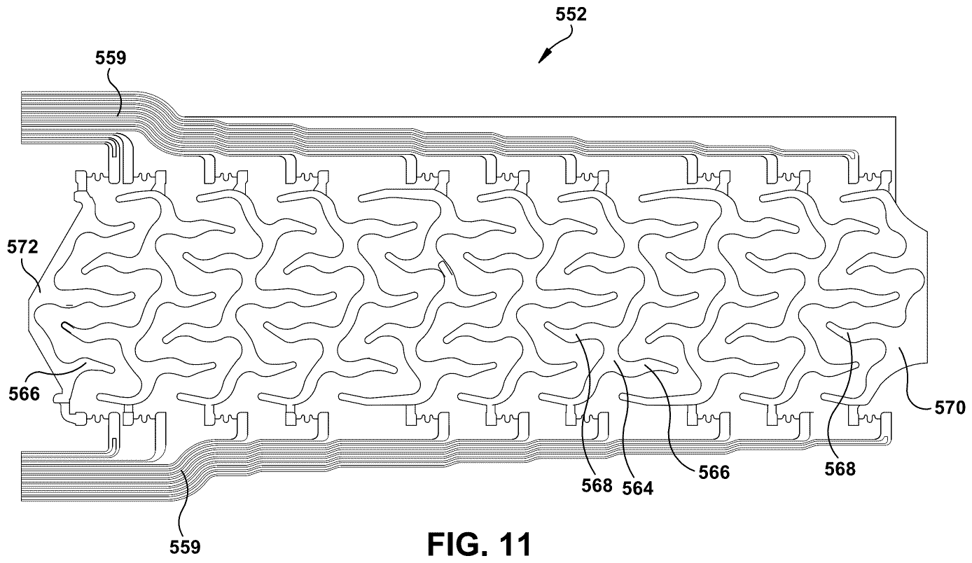

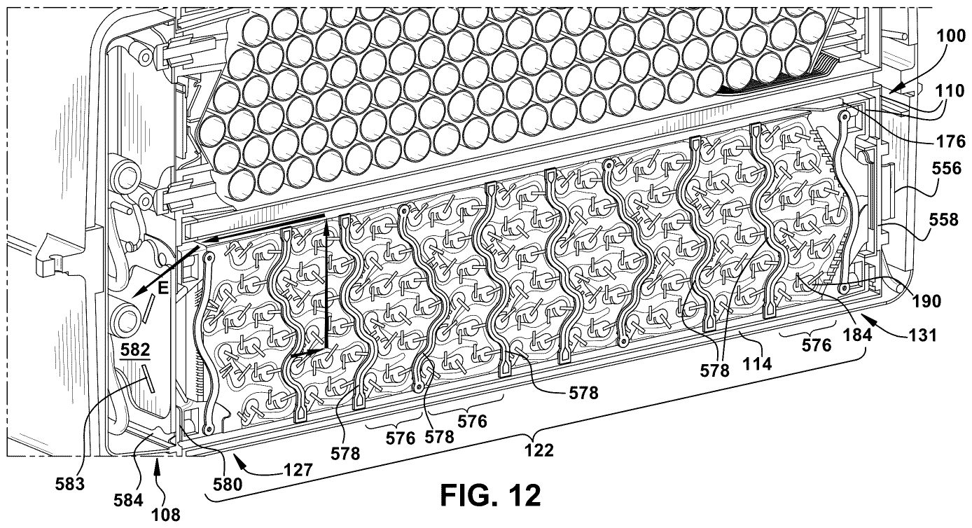

As seen in FIG. 11, conductive layer 552 can in embodiments include measurement leads 559 as well as a front collector segment 570 and a back collector segment 572. One or more intermediate collector segments 564 can also be included as may be suitable and/or desired to achieve a particular interconnection of cells 120 (FIGS. 1-4), such as to achieve a desired voltage and/or current capacity. Each intermediate collector segment 564 can include one or more front fingers 566 and one or more back fingers 568. Front collector segment 570 can include one or more back fingers 568, and back collector segment 572 can include one or more front fingers 566. With additional reference to FIGS. 1-4 and 12, collector segments 564, 570, 572 can be used to connect cells 120 (FIGS. 1-4) in parallel in units 576 (FIG. 12), to connect the units 576 (FIG. 12) in series, and to electrically connect the units 576 (FIG. 12) to busbar 554 (FIG. 5) through front collector segment 570 and subpack electrical terminals 556 (FIG. 5) via back collector segment 572. In embodiments, conductive layer 552 has one more collector segment 564, 570, 572 than a desired number of units 576 (FIG. 12). In the example shown, eight intermediate collector segments 564 are included so that, with front and back collector segments 570, 572, conductive layer 552 is configured to connect nine units 576 (FIG. 12) in series and separated by an insulative barrier 578 (FIG. 12), each unit 576 (FIG. 12) having fourteen cells connected in parallel, producing a 14PS9 arrangement for a side of battery subpack 100 (FIGS. 1-4). Each intermediate collector segment 564 will have all front fingers 566 connected to one type of electrode of cells 120 (FIGS. 1-4), and will have all back fingers 568 connected to the other type of electrode of cells 120 (FIGS. 1-4). For example, back fingers 568 of front collector segment 570 can be connected to cathodes 190 (FIG. 12) of a first unit 576 (FIG. 12) of fourteen cells 120, interlaced front fingers 566 of the frontmost intermediate collector segment 564 can be connected to anodes 184 (FIG. 12) of the same fourteen cells 120, and back fingers 568 of the frontmost intermediate collector segment 564 can be connected to cathodes 190 (FIG. 12) of a second unit 576 (FIG. 12) of fourteen cells 120. Anodes 184 (FIG. 12) of the second unit 576 (FIG. 12) of fourteen cells 120 can be connected to front fingers 566 of a next intermediate collector segment 564 and so on ending with front fingers 566 of back collector segment 572 connected to anodes 184 (FIG. 12) of a ninth unit 576 (FIG. 12) of fourteen cells 120. Back collector segment 572 would be connected to a negative terminal 556 of battery subpack 100 (FIGS. 3 and 9). In this example, a corresponding current collector 550 on the opposite side of battery subpack 100 would have its front collector segment 570 connected to busbar 554 and its intermediate sections 564 connected to electrodes of cells 120 so that its back collector segment 572 would be connected to a positive terminal 556 of battery subpack 100 (FIGS. 3 and 9). Thus, the current collectors 550 are connected in series by busbar 554 to negative and positive terminals 556 of battery subpack 100 to provide, in the example shown, a 14PS18 battery subpack.

Embodiments of the disclosure provide various technical and commercial advantages, examples of which are discussed herein. A technical effect of a battery subpack and cell array therefore according to aspects of the disclosure is to resist propagation of thermal runaway from one cell to others within a battery subpack cell group.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise. “Approximately” or “about,” as applied to a particular value of a range, applies to both end values and, unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiments were chosen and described in order to best explain the principles of the disclosure and the practical application of such technology and to enable others of ordinary skill in the art to understand the various embodiments of the present disclosure and the possibility of various modifications of the disclosed embodiments, as may be suited to the particular use(s) contemplated.

While the disclosure has been described in detail in connection with only a limited number of embodiments, it should be readily understood that the disclosure is not limited to such disclosed embodiments. Rather, the disclosure can be modified to incorporate any number of variations, alterations, substitutions, or equivalent arrangements not heretofore described, but which are commensurate with the spirit and scope of the disclosure. Additionally, while various embodiments of the disclosure have been described, it is to be understood that aspects of the disclosure may include only some of the described embodiments. Accordingly, the disclosure is not to be seen as limited by the foregoing description, but is only limited by the scope of the appended claims.

What is claimed is:

1. A cell array comprising:
a first cell having a base, a vent end, a central axis, and an outer surface;
a plurality of neighbor cells identical to the first cell and arranged with the respective central axes parallel to the central axis of the first cell and with the respective bases coplanar with the base of the first cell, wherein the plurality of neighbor cells includes at least three neighbor cells; and
a respective thermal gap defined between the outer surface of the first cell and the respective outer surface of each neighbor cell, wherein the respective thermal gap is sized to maintain a thermal load on each neighbor cell below a predetermined threshold thermal load where the first cell enters a thermal runaway state.

2. The cell array of claim 1, wherein the plurality of neighbor cells is arranged with respective central axes thereof at points of a regular hexagon centered on the central axis of the first cell.

3. The cell array of claim 1, further comprising an outer layer of cells and a first internal layer of cells, wherein each cell of the outer layer of cells is a neighbor cell for at least one cell of the first internal layer of cells, and wherein each cell of the first internal layer of cells has at least two cells of the outer layer of cells as respective neighbor cells.

4. The cell array of claim 1, wherein the respective base of each cell engages a first surface of a heat exchange device.

5. The cell array of claim 4, wherein the cell array is a first cell array, and a second cell array identical to the first cell array is arranged such that the respective base of each cell of the second cell array engages a second surface of the heat exchange device, wherein the second surface of the heat exchange device is opposite the first surface of the heat exchange device.

6. The cell array of claim 1, wherein a thermally insulative material occupies each thermal gap.

7. A battery subpack comprising:
a subpack enclosure;
a heat exchange device in the subpack enclosure, wherein the heat exchange device has a first surface, a second surface opposite the first surface, a fluid passage between the first surface and the second surface, a fluid inlet, and a fluid outlet; and
a first cell array including:
a first cell having a base, a vent end, a central axis, and an outer surface;
a plurality of neighbor cells identical to the first cell and arranged with respective central axis is parallel to the central axis of the first cell, wherein the plurality of neighbor cells includes at least three neighbor cells; and
a respective thermal gap defined between the outer surface of the first cell and the respective outer surface of each neighbor cell, wherein the respective thermal gap is selected to maintain a thermal load on each neighbor cell below a predetermined threshold thermal load responsive to the first cell entering a thermal runaway state,
wherein the first cell array is arranged with the respective bases of the cells of the first cell array engaged with the first surface of the heat exchange device.

8. The battery subpack according to claim 7, wherein a plurality of the first cell arrays is arranged to form a first outer layer of cells consisting of neighbor cells.

9. The battery subpack according to claim 7, further comprising a second cell array identical to the first cell array, wherein the cells of the second cell array engage the second surface of the heat exchange device.

10. The battery subpack according to claim 9, wherein a plurality of the first cell arrays is arranged to form a first outer layer of cells consisting of neighbor cells, and a plurality of the second cell arrays is arranged to form a second outer layer of cells consisting of neighbor cells.

11. The battery subpack of claim 7, wherein a thermally insulative material occupies each thermal gap.

12. The battery subpack of claim 7, further comprising a current collector disposed between the vent ends of the cells of the first cell array and a corresponding wall of the subpack enclosure, wherein the current collector is in electrical communication with contacts of the cells of the first cell array and with a subpack electrical terminal formed in a back end of the subpack enclosure, wherein the current collector is dimensioned and a material of the current collector is selected to enable ejecta from the vent ends of the cells of the first cell array to pass through the current collector during a thermal runaway event.

13. The battery subpack of claim 12, wherein the current collector includes holes aligned with the vent ends of the cells of the first cell array.

14. The battery subpack of claim 12, wherein a thickness of the current collector is selected such that the ejecta from a thermal runaway event destroys material of the current collector in a path of the ejecta to pass through the current collector.

15. The battery subpack of claim 12, wherein a material of the current collector includes aluminum.

16. The battery subpack of claim 12, wherein the current collector comprises:
a first electrically insulative layer made from a first polymer;
a second electrically insulative layer made from a second polymer; and
a first electrically conductive layer between the first electrically insulative layer and the second electrically insulative layer, wherein the first electrically conductive layer is in electrical communication with respective first electrodes of the cells of the first cell array.

17. The battery subpack of claim 16, wherein at least one of the first polymer or the second polymer includes polyethylene terephthalate (PET).

18. The battery subpack of claim 16, wherein the first electrically conductive layer includes aluminum.

19. A battery subpack comprising:
a subpack enclosure including a front end and a back end opposite the front end;
a heat exchange device extending from the front end to the back end of the subpack enclosure, the heat exchange device including a first surface facing a first side wall of the subpack enclosure, a second surface facing a second side wall of the subpack enclosure, a fluid inlet, and a fluid outlet, wherein at least one of the fluid inlet or the fluid outlet is disposed at the front end of the subpack enclosure; and
a first cell group on the first surface of the heat exchange device and a second cell group on the second surface of the heat exchange device, wherein each of the first cell group and the second cell group includes a plurality of cell arrays each including:
a first cell having a base, a vent end, a central axis, and an outer surface;
a plurality of neighbor cells identical to the first cell wherein each respective central axis is parallel to the central axis of the first cell, wherein the plurality of neighbor cells includes at least three neighbor cells;
a respective thermal gap defined between the outer surface of the first cell and the respective outer surface of each neighbor cell, wherein the respective thermal gap is selected to maintain a thermal load on each neighbor cell below a predetermined threshold thermal load where the first cell enters a thermal runaway state; and
a current collector adjacent the vent ends of the cells and in electrical communication with electrodes thereof and with a terminal at the back end of the subpack enclosure,
wherein the respective bases of the cells of the first cell group and the second cell group have a direct thermal connection with the first surface of the heat exchange device and the second surface of the heat exchange device, respectively, and
wherein the respective vent ends of the cells of the first cell group and the second cell group are proximate and spaced apart from the first side wall of the subpack enclosure and the second side wall of the subpack enclosure, respectively, such that respective vent gaps are defined between the respective side walls of the subpack enclosure and the respective collectors of the first cell group and the second cell group.

20. The battery subpack of claim 19, wherein each current collector includes a pair of terminals in electrical communication with respective connectors extending through a back end wall of the subpack enclosure.
